(19) United States
(12) Patent Application Publication
(10) Pub. No.: US 2009/0108502 A1
(43) Pub. Date: Apr. 30, 2009

(54) LASER PROCESSING MASK AND LASER PROCESSING METHOD

(76) Inventors: Yasutaka Kogetsu, Osaka (JP); Yoshifumi Taguchi, Osaka (JP)

Correspondence Address: MCDERMOTT WILL & EMERY LLP, 600 13TH STREET, NW, WASHINGTON, DC, 20005-3096, US

(21) Appl. No.: 12/255,977

(22) Filed: Oct. 22, 2008

(30) Foreign Application Priority Data
Oct. 31, 2007 (JP) 2007-282638

(51) Int. Cl. B32B 3/10; B29C 35/08

(52) U.S. Cl. 264/400; 428/131

(57) ABSTRACT

In a laser processing mask, apertures formed thereon as laser light passing apertures are shaped so that a plurality of protrusions extend radially from the center of each of the apertures to the peripheral portion thereof. By using this laser processing mask, a recess pattern with dimensions of several micrometers to several tens of micrometers and high dimensional precision and shape precision can be formed on the surface of a workpiece made of, for example, a metal material by laser processing.

### FIELD OF THE INVENTION

The present invention relates to a laser processing mask, and to a laser processing method. More particularly, the present invention mainly relates to an improvement of apertures that are formed on a laser processing mask for applying laser.

### BACKGROUND OF THE INVENTION

Lithium ion secondary batteries have high capacity and high energy density and their size and weight reduction can be easily achieved. Therefore, lithium ion secondary batteries are widely used as a power source for portable small electronic devices, including mobile phones, personal digital assistants (PDAs), notebook personal computers, camcorders, and portable game devices. In a typical lithium ion secondary battery, a positive electrode containing a lithium cobalt compound as the positive electrode active material, a negative electrode containing a carbon material as the negative electrode active material, and a separator of a polyolefin porous film are used. Lithium ion secondary batteries have high battery capacity and high output, as well as excellent charge and discharge cycle performance, and relatively long durable life. However, under current situations where portable small electronic devices are becoming multifunctional and extension of continuously usable time is demanded, lithium ion secondary batteries are required to have even higher capacity.

For achieving even higher capacity lithium ion secondary batteries, for example, development of a high capacity negative electrode active material is in progress. As a high capacity negative electrode active material, alloy-based negative electrode active materials are gaining attention. The alloy-based negative electrode active materials absorb lithium by being alloyed with lithium, and reversibly absorb and desorb lithium. Known alloy-based negative electrode active materials include, for example, silicon, tin, oxides of these, nitrides of these, compounds containing these, and alloys containing these. The alloy-based negative electrode active material has a high discharge capacity. For example, Japanese Laid-Open Patent Publication No. 2002-83594 mentions that silicon has a theoretical discharge capacity of about 4199 mAh/g, which is about eleven times the theoretical discharge capacity of graphite, which has been used as the negative electrode active material heretofore.

The alloy-based negative electrode active material is effective in terms of achieving a high capacity lithium ion secondary battery. However, for realizing practical use of a lithium ion secondary battery containing the alloy-based negative electrode active material, there are some problems to be solved. For example, alloy-based negative electrode active materials repeatedly expand and contract every time they absorb and desorb lithium ions, and with the expansion and contraction, a relatively large stress is caused. Such stress may cause cracks of the negative electrode active material layer, separation of the negative electrode active material layer from the negative electrode current collector, deformation of the negative electrode current collector and hence the negative electrode as a whole, and a decline in charge and discharge cycle performance of the lithium ion secondary battery.

In view of such problems, Japanese Laid-Open Patent Publication No. 2007-103197 has proposed providing projections (protruded portions) on the surface of the negative electrode current collector in a lithium ion secondary battery including a negative electrode active material layer containing an alloy-based negative electrode active material. According to this patent publication, the projections are provided on the surface of the negative electrode current collector to increase the bonding strength between the negative electrode current collector and the negative electrode active material layer, in an attempt to prevent separation of the negative electrode active material layer resulting from the expansion and contraction of the alloy-based negative electrode active material. However, in the technique of this patent publication, the projections are formed by electrolytic deposition, i.e., electroplating, and therefore the bonding strength between the negative electrode current collector and the projection is not sufficiently high. Thus, due to the stress resulting from the expansion and contraction of the alloy-based negative electrode active material, the projections easily separate from the negative electrode current collector, failing to sufficiently prevent the separation of the negative electrode active material layer.

Meanwhile, Japanese Laid-Open Patent Publication No. 2007-27252 has proposed a method for forming projections and recesses on the surface of a substrate made of, for example, metal. In this patent publication, a roller on the surface of which projections and recesses are formed is used. The projections and recesses are formed on the surface of a substrate by using a pair of these rollers, bringing these rollers into press-contact so that their axes are parallel with each other, passing the substrate material through the press-contact portion between these rollers, and applying a pressure to plastically deform the material constituting the substrate. Also, in this patent publication document, the rollers are made by forming projections and recesses on the surface of a resin film by laser processing, rolling the resin film in a cylindrical form with its surface having the projections and recesses disposed inside, and depositing metal on the surface where the projections and recesses are formed by electroforming.

However, in this roller making method, since resin films are easily deformed, the projections and recesses formed on the surface of the resin film are often not transferred accurately on the roller surface. Such a tendency becomes further notable when the projections and recesses are sized in the order of several micrometers. Therefore, when using a roller obtained by this method, it is difficult to form, on the surface of the substrate, a pattern of projections and recesses in which minute projections with a height and a diameter of about several micrometers are arranged regularly.

### BRIEF SUMMARY OF THE INVENTION

The inventors of the present invention have conducted studies for preventing cracking of the negative electrode active material layer, separation of the negative electrode active material layer, and deformation of the negative electrode in lithium secondary batteries containing an alloy-based active material as the negative electrode active material. In the process of such studies, the inventors have found that the problems in the past techniques can be solved substantially by forming a regular pattern of minute projections with a height and a dimension of in the order of several micrometers on the surface of the negative electrode current collector by plastic deformation, and forming a negative electrode active material layer on the surface of the projections.

Furthermore, the inventors of the present invention have found that minute projections can be accurately formed on the surface of the negative electrode current collector by plastic deformation, by forming a pattern of recesses corresponding to the projections in size, shape, and arrangement on the surface of a roller; forming a press-contact portion by bringing two such rollers into press-contact; and passing a negative electrode current collector through this press-contact portion.

The inventors of the present invention have conducted further studies on a method for forming a pattern of recesses on the surface of a roller based on the founding above. To reproduce a pattern of recesses corresponding to the projections in size, shape, and arrangement accurately on the surface of the roller, it is industrially advantageous to use laser processing. However, it was found that it is very difficult to form minute projections with a diameter and a height in the order of several micrometers by a general laser processing method. In a laser processing method, a mask is disposed between a laser light source and a roller mainly made of an iron-based metal material such as stainless steel. A plurality of apertures having the same size and shape as the horizontal section of the projections are formed on the mask. By applying laser light through the mask, a recess pattern corresponding to the projection pattern is formed on the surface of the roller.

However, when the size of the projections is minute, due to the fact that the roller surface tends to be in a molten state from the laser irradiation and that the roller surface is not flat, the shape of individual recesses formed on the roller surface are different from the designed shape of the projections. Accordingly, it is very difficult to accurately reproduce the shape of the projections. Also, the dimensions of the recess such as the diameter and the depth tend to be larger than the actual dimensions, such as the diameter and the height, of the projection.

Even if the laser irradiation time, the laser irradiation interval, and the laser light intensity are adjusted, industrially, it is very difficult to form a plurality of recesses that have dimensions and a shape substantially identical to those of the projections. Also, even if a mask having apertures with a shape similar to that of the horizontal section of the projections and with dimensions slightly smaller than those of the projections is used, it is industrially difficult to form a plurality of recesses that have a shape and dimensions substantially identical with those of the projections.

An object of the present invention is to provide a laser processing mask that is effective in forming a pattern of projections and recesses with minute dimensions in the order of several micrometers on the surface of a workpiece made of, for example, a metal material, and to provide a laser processing method using the laser processing mask.

As a result of diligent studies for solving the above-described problems, the inventors of the present invention have succeeded in obtaining a laser processing mask, in which apertures with a specific shape are formed and that is capable of accurately reproducing a pattern of projections and recesses with minute dimensions in the order of several micrometers, thereby completing the present invention.

That is, the present invention relates to a laser processing mask including a plurality of apertures perforating the laser processing mask in the thickness direction thereof, wherein the apertures have a shape in which a plurality of protrusions extend radially from the center of each of the apertures to the peripheral portion thereof.

The apertures preferably have a shape in which an even number of protrusions are arranged so as to oppose one another with the center of each of the apertures interposed therebetween.

Further preferably, the apertures have a cross shape in which four protrusions are disposed so that any one of the four protrusions arranged so as to oppose one another with the center of each of the apertures interposed therebetween; and length L₁ of a straight line connecting apexes of one pair of protrusions opposing each other, and length L₂ of a straight line connecting apexes of the other pair of protrusions opposing each other are different.

L₁ is 60 μm to 1.2 mm, L₂ is 30 to 600 μm, and L₁ is larger than L₂.

Sides of the apertures are preferably indented toward the center of the apertures with respect to an imaginary line formed by connecting the apexes of adjacent protrusions.

An imaginary plane formed by connecting apexes of adjacent of protrusions is preferably substantially in the shape of a polygon.

The polygon is preferably a tetragon, a hexagon, or an octagon.

The end portion of the protrusions is preferably semicircular.

The mask is preferably used in laser processing of hard metal, high-speed steel, or forged steel.

The mask is further preferably used in laser processing of a roller including a laser processing layer containing hard metal, high-speed steel, or forged steel on at least its circumferential surface.

The present invention also relates to a laser processing method, including the step of: applying laser light to a surface of a workpiece through any one of the laser processing masks in accordance with the present invention.

By performing laser processing using a laser processing mask of the present invention, minute patterns of projections and recesses in the order of several micrometers can be accurately and easily formed on the surface of a workpiece such as a roller. Particularly, the shape, the dimensions (diameter, depth of the recesses, and height of projection), and the arrangement of the pattern of projections and recesses can be reproduced substantially accurately. That is, using a laser processing mask of the present invention makes it possible to provide a roller on the surface of which recesses with a shape and dimensions substantially corresponding to those of projections in the order of several micrometers are formed. By carrying out plastic deformation processing for a current collector by using this roller, projections having a shape substantially as a designed shape and dimensions in the order of several micrometers can be formed in an industrially advantageous way on the surface of the current collector.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a top view schematically illustrating the configuration of a laser processing mask according to an embodiment of the present invention.

FIG. 2 is a top view illustrating the shape of apertures formed on the laser processing mask shown in FIG. 1.

FIG. 3 is a top view schematically illustrating the shape of apertures in a laser processing mask according to another embodiment of the present invention.

FIG. 4 is a top view schematically illustrating the shape of apertures in a laser processing mask according to another embodiment of the present invention.

FIG. 5 is a top view schematically illustrating the shape of apertures in a laser processing mask according to another embodiment of the present invention.

FIG. 6 is a top view schematically illustrating the shape of apertures in a laser processing mask according to another embodiment of the present invention.

FIG. 7 is a top view schematically illustrating the shape of apertures in a laser processing mask according to another embodiment of the present invention.

FIG. 8 is a perspective view schematically illustrating the configuration of a laser processing device.

FIG. 9 is a perspective view illustrating the operation of a mask in the laser processing device shown in FIG. 8.

FIG. 10 is a graph illustrating an example of the operation of a beam diameter adjusting means.

### DETAILED DESCRIPTION OF THE INVENTION

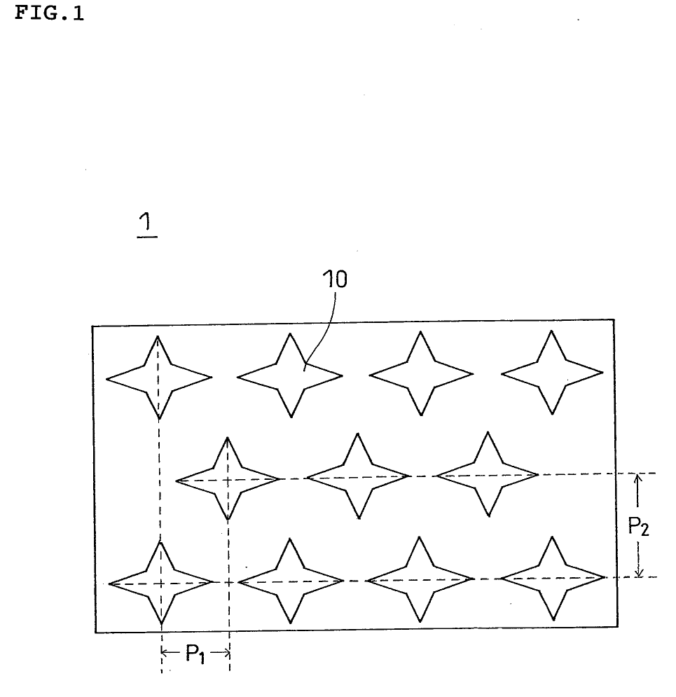

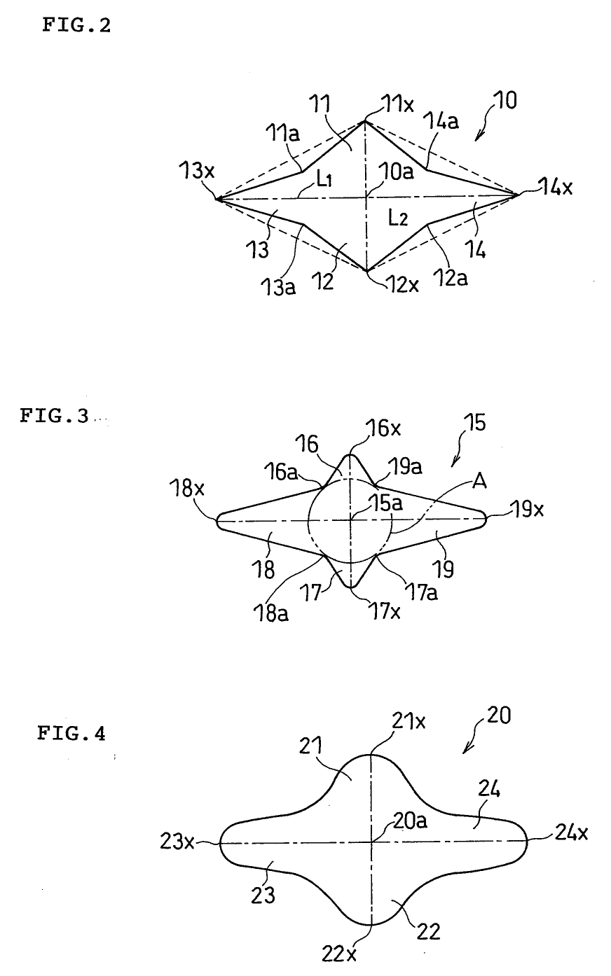

FIG. 1 is a top view schematically illustrating the configuration of a laser processing mask 1 according to an embodiment of the present invention. FIG. 2 is a top view illustrating the shape of apertures 10 formed on the laser processing mask 1. FIG. 2 shows the shape of the aperture 10 when the laser processing mask 1 placed on a plane parallel to the horizontal plane is viewed from vertically above. The laser processing mask 1 characteristically includes a plurality of the apertures 10. The laser processing mask 1 is suitable for forming recesses in the shape of, for example, a rectangle or a diamond with dimensions of several micrometers to several tens of micrometers by laser processing on the surface of a workpiece.

The laser processing mask 1 is a sheet member, and made of, for example, a metal material such as copper, stainless steel, and the like. When laser light is applied through the laser processing mask 1 and a converging lens to a workpiece (not shown) disposed on the image plane of the mask by the converging lens, a pattern of recesses in which the shape of the apertures of the mask 1 is magnified or reduced is formed on the surface of the workpiece. By plastically deforming a metal sheet current collector by applying pressure using the workpiece with the recess pattern formed, a pattern of projections that corresponds to the recess pattern is formed on the surface of the current collector. For example, a columnar active material layer is formed on the surface of the projections. In the following, a workpiece to which laser processing is carried out by using the laser processing mask 1 is simply referred to as a “workpiece”.

The aperture 10 perforates the laser processing mask 1 in the thickness direction thereof, and has a cross shape with an even number of protrusions 11, 12, 13, and 14 extending radially from a center 10a of the aperture 10 toward the peripheral portion. In the aperture 10, the protrusions 11 and 12 are disposed so as to oppose each other with the center 10a therebetween, and the protrusions 13 and 14 are also disposed so as to oppose each other with the center 10a therebetween, thereby the aperture 10 is formed into a cross shape.

Here, the center 10a of the aperture 10 is an intersection point of a dash-dotted line connecting an apex 11x of the protrusion 11 and an apex 12x of the protrusion 12, and a dash-dotted line connecting an apex 13x of the protrusion 13 and an apex 14x of the protrusion 14. The apex 11x of the protrusion 11 is a point in the protrusion 11 where the length from the center 10a is the longest.

Although an even number of protrusions 11, 12, 13, and 14 are formed in this embodiment, the number of protrusions is not limited thereto, and for example, 3 or 5 protrusions may be formed to form apertures of, for example, a substantially triangle, starfish, or star shape.

Length L₁ of a dash-dotted line connecting the apexes 13x and 14x, and length L₂ of a dash-dotted line connecting the apexes 11x and 12x preferably satisfy the relation L₁>L₂. By setting the lengths of L₁ and L₂ to be different, the reproducibility of the shape, and the reproducibility of the dimensions, especially the shape reproducibility, further improves when the shape of the recesses to be formed on the surface of the workpiece is, for example, a rectangle or a diamond. Here, the shape of the recesses is the shape of the recesses of a workpiece placed on a plane parallel to the horizontal plane, as viewed from vertically above, when the workpiece is, for example, a sheet member or a plate member.

When the workpiece is a roller member, the shape of the recess is the shape of the cross section that includes the center of the shape of the recess and that is cut in the direction vertical to the axis of the roller member. Almost the same shape is possessed with the recess and the aperture 10. Therefore, the center of the recess shape and the center of the aperture 10 mostly coincide.

It is preferable that, in the shape of the recess formed on the surface of the workpiece, length L₁ coincides with the longest line among the lines passing through the center of the shape of the recess, and that length L₂ coincides with the longest of the lines orthogonal to the above-described longest line. Thus, the shape reproducibility and the dimension reproducibility improve even further.

Although the length of the dash-dotted line connecting the apexes 13x and 14x is taken as L₁ and the length of the dash-dotted line connecting the apexes 11x and 12x is taken as L₂ in this embodiment, instead, the length of the dash-dotted line connecting the apexes 13x and 14x may be taken as L₂, and the length of the dash-dotted line connecting the apexes 11x and 12x may be taken as L₁. In this case as well, L₁ and L₂ satisfy the relation L₁>L₂.

Length L₁ is preferably 60 μm to 1.2 mm, and further preferably 100 μm to 900 μm; and length L₂ is preferably 30 to 600 μm, and further preferably 50 to 450 μm, although the lengths of L₁ and L₂ are not particularly limited thereto. By setting L₁ and L₂ within such ranges, the dimension reproducibility of the laser processing mask 1 can be further improved. Furthermore, the design flexibility for the pattern of forming the recesses on the surface of the workpiece can be increased. Also, the bonding strength between the surface of the projections corresponding to the recesses and the columnar active material layer can be improved, and also this bonding strength can be maintained at a high level for a long period of time.

Also, by setting L₁ and L₂ within the above preferable ranges, and adjusting the length of the portion corresponding to L₁ to 6 to 40 μm, and the length of the portion corresponding to L₂ to 3 to 20 μm in the laser light irradiation area of the surface of the workpiece, recesses with a shape that matches the projection shape more precisely can be formed.

Furthermore, by setting L₁ and L₂ within the preferable ranges, and adjusting the length of the portion corresponding to L₁ to 10 to 30 μm and the length of the portion corresponding to L₂ to 5 to 15 μm in the laser light irradiation area of the surface of the workpiece, recesses with a shape that matches the projection shape even more accurately can be formed. Such an adjustment can be carried out easily, for example, by appropriately selecting the converging lens and the distance between the laser processing mask 1 and the workpiece.

The four sides of the aperture 10 are indented toward the center 10a of the aperture 10 with respect to an imaginary line formed by connecting the apexes 11x, 12x, 13x, and 14x of adjacent of the protrusions 11, 12, 13, and 14. The adjacent of protrusions are the protrusions 11 and 13, the protrusions 11 and 14, the protrusions 12 and 13, and the protrusions 12 and 14. The imaginary line is shown by the broken line in FIG. 2. For example, the side including the apexes 11x and 13x of the protrusions 11 and 13 is indented toward the center 10a of the aperture 10 with respect to the imaginary line connecting the apexes 11x and 13x. The same applies to the other sides as well. By adjusting the degree of such an indentation appropriately, the dimensions of the recesses can be prevented from becoming larger than the designed values. Furthermore, the shape reproducibility when the shape of the recess is, for example, a rectangle or a diamond can be further improved. Preferably, the apex of the indentation is determined so that a rectangle is formed by connecting the apexes 11a, 13a, 12a, and 14a of the indentations of the sides connecting the adjacent protrusions in this order.

Preferably, the shape of an imaginary plane formed by connecting the apexes 11x, 12x, 13x, and 14x of adjacent pairs of the protrusions 11, 12, 13, and 14 is substantially a polygon. Among various examples of polygon, tetragon, hexagon, and octagon are preferable. Tetragon and hexagon are more preferable. Tetragon includes a rectangle and a diamond. In this embodiment, the shape of the imaginary plane is a diamond. By allowing the shape of the imaginary plane and the shape of the designed recess to match each other, the designed shape of the projection can be reproduced very accurately. That is, the shape reproducibility further improves.

Although the end portion of the protrusions 11, 12, 13, and 14 is tapered and acute angled in this embodiment, the present invention is not limited thereto, and a line with a radius of curvature, that is, a curve may be used to form the end portion of the protrusions. To be more specific, the end portion of the protrusions 11, 12, 13, and 14 may be, for example, substantially semi-circular and substantially semi-oval. When the end portion has such a shape, the shape reproducibility in the proximity of the end portion further improves.

Furthermore, although the apertures 10 are arranged in the laser processing mask 1 in a staggered configuration in this embodiment, the arrangement is not limited thereto. For example, the apertures may be arranged vertically and horizontally parallel with equal intervals, or may be arranged obliquely parallel with equal intervals.

Although pitch P₁ in the longitudinal direction of the aperture 10 in the laser processing mask 1 of the present invention is not particularly limited, and can be appropriately selected from a wide range depending on, for example, the dimensions of the aperture 10, the shape of the aperture 10, and the like. Pitch P₁ is preferably 8 to 30 μm, and further preferably 15 to 30 μm. The longitudinal direction of the mask 1 corresponds to the longitudinal direction of the workpiece, and corresponds to the longitudinal direction of the roller when the workpiece is a roller. Pitch P₂ in the latitudinal direction of the aperture 10 is also not particularly limited, and can be appropriately selected from a wide range depending on the dimensions of the aperture 10, the shape of the aperture 10, and the like. However, pitch P₂ is preferably 0 to 10 μm, and further preferably 2 to 8 μm. The latitudinal direction of the mask 1 corresponds to the latitudinal direction of the workpiece, and corresponds to the circumferential direction of the roller when the workpiece is a roller.

When recesses are formed on a workpiece by using the laser processing mask 1 having pitch P₁ and pitch P₂ as described above, the pitch in the longitudinal direction of the recess will be 8 to 30 μm, preferably 15 to 30 μm, and the pitch in the latitudinal direction of the recess will be 5 to 20 μm, preferably 10 to 20 μm. Herein, the pitch means the distance between a center line of a horizontal (longitudinal direction) or in the vertical (latitudinal direction) row of the recesses, and a center line of a row of the recesses in a different phase and is adjacent to the aforementioned row. The center line of a row of the recesses is a straight line connecting the center points of the recesses that correspond to the centers 10a of the apertures 10, in any of the longitudinal direction and in the latitudinal direction.

The laser processing mask 1 is used for laser processing a workpiece containing a metal material. Examples of the metal material include, but not particularly limited to, an iron-based material such as stainless steel. High melting point metal materials such as hard metal, cermet, high-speed steel, die steel, and forged steel are preferable. Among these, hard metal, high-speed steel, and forged steel are further preferable, and forged steel is particularly preferable. Because these high melting point metal materials can be laser processed, have a higher melting point and a higher boiling point than an iron-based material such as stainless steel, and their molten state lasts for a short period of time, the reproducibility of the shape and the dimensions is excellent. Additionally, these high melting point materials have not only a high melting point, but also a high mechanical strength. Therefore, even if plastic deformation processing of the current collector is carried out repeatedly, it is very unlikely that the shape of the recesses is deformed, and they are therefore highly durable for a long time. The workpiece may include a single metal material, or may include two or more metal materials.

The form of the workpiece is preferably in a plate form or in a roller form, and the roller form is particularly preferable, although it is not limited thereto. Examples of the roller-form workpiece include a metal roller and a surface cover roller. The metal roller is a roller obtained by forming one or more metal materials selected from above into a roller form. The surface cover roller includes a core roll and a surface covering layer provided on the surface of the core roll. For the core roll, a metal material commonly used for rollers, such stainless steel and iron, may be used. The surface covering layer includes one or more metal materials selected from the metal materials described above. The thickness of the surface covering layer is not particularly limited, but for example, when the metal material is a high melting point metal material, it is preferably about 5 to 50 mm. When both of the core roll and the surface covering layer are made of stainless steel, the hardness of the stainless steel contained in the surface covering layer is preferably higher than that of the stainless steel contained in the core roll.

The surface cover roller can be made by a commonly used method, when the metal material contained in the surface covering layer is, for example, stainless steel. When the metal material contained in the surface covering layer is a high melting point metal material, for example, the surface cover roller can be made by forming the high melting point material into a cylindrical shape, and fitting the obtained cylinder of the high melting point material with the core roll by thermal fitting or cool fitting. In thermal fitting, the high melting point material cylinder is made so that the inner diameter of the high melting point material cylinder is slightly smaller than the external diameter of the core roll, and this high melting point material cylinder is warmed to expand, and the core roll is inserted into the cylinder. In cool fitting, a core roll shrunk by cooling is inserted into a cylinder of the high melting point material, which is made so that the inner diameter of the high melting point material cylinder is slightly smaller than the external diameter of the core roll.

A projecting forming roller is obtained by carrying out laser processing for this surface cover roller to form recesses using the laser processing mask 1. When the projections are formed on a current collector by using this projection forming roller, extremely high dimensional precision can be maintained for a long period of time, similarly to a precisely made metal mold.

Known hard metals may be used as the hard metal, including for example, a hard metal made by sintering particles of a carbide of metal in Group 4A, 5A, and 6A in the Periodic Table of the Elements using a binder of metal such as Fe, Co, and Ni. Specific examples of the hard metal include tungsten carbide-based hard metals such as a WC—Co-based hard metal, a Wc-Cr₃C₂—Co-based hard metal, a WC—TaC—Co-based hard metal, a WC—TiC—Co-based hard metal, a WC—NbC—Co-based hard metal, a WC—TaC—NbC—Co-based hard metal, a WC—TiC—TaC—NbC—Co-based hard metal, a WC—TiC—TaC—Co-based hard metal, a WC—ZrC—Co-based hard metal, a WC—TiC—ZrC—Co-based hard metal, a WC—TaC—VC—Co-based hard metal, a WC—TiC—Cr₃C₂—Co-based hard metal, a WC—TiC—TaC-based hard metal, a WC—Ni-based hard metal, a WC—Co—Ni-based hard metal, a WC—Cr₃C₂—Mo₂C—Ni-based hard metal, a WC—Ti(C,N)—TaC-based hard metal, and a WC—Ti(C,N)-based hard metal; a Cr₃C₂—Ni-based hard metal; and the like.

Known cermets may be used, including, for example, a TiC—Ni-based cermet, a TiC—Mo—Ni-based cermet, a TiC—Co-based cermet, a TiC—Mo₂C—Ni-based cermet, a TiC—Mo₂C—ZrC—Ni-based cermet, a TiC—Mo₂C—Co-based cermet, a Mo₂C—Ni-based cermet, a Ti(C,N)—Mo₂C—Ni-based cermet, a TiC—TiN—Mo₂C—Ni-based cermet, a TiC—TiN—Mo₂C—Co-based cermet, a TiC—TiN—Mo₂C—TaC—Ni-based cermet, a TiC—TiN—Mo₂C—WC—TaC—Ni-based cermet, a TiC—WC—Ni-based cermet, a Ti(C,N)—WC—Ni-based cermet, a TiC—Mo-based cermet, a Ti(C,N)—Mo-based cermet, and a boride-based cermet (for example, a MoB—Ni-based cermet, a B₄C/(W,Mo)B₂-based cermet), and the like. Among these, titanium carbonitride-based cermets such as a Ti(C,N)—Mo₂C—Ni-based cermet, a TiC—TiN—Mo₂C—Ni-based cermet, a TiC—TiN—Mo₂C—Co-based cermet, a TiC—TiN—MO₂C—TaC—Ni-based cermet, a TiC—TiN—Mo₂C—WC—TaC—Ni-based cermet, a Ti(C,N)—WC—Ni-based cermet, and a Ti(C,N)—Mo-based cermet are preferable.

The high-speed steel is a material made by adding metals such as molybdenum, tungsten, and vanadium to iron, and further carrying out a heat treatment to increase hardness. Known high-speed steel can be used, including, for example, high-speed steel mainly composed of iron and containing carbon, tungsten, vanadium, molybdenum, and chromium; high-speed steel mainly composed of iron and containing carbon, tungsten, vanadium, molybdenum, cobalt, and chromium; high-speed steel mainly composed of iron and containing carbon, vanadium, molybdenum, and chromium; high-speed steel mainly composed of iron and containing silicon, manganese, chromium, molybdenum, and vanadium; high-speed steel mainly composed of iron and containing carbon, silicon, manganese, chromium, molybdenum, and vanadium; high-speed steel mainly composed of iron and containing carbon, silicon, manganese, chromium, molybdenum, tungsten, cobalt, and vanadium; and the like.

Known die steel can be used, including, for example, die steel containing iron, carbon, tungsten, vanadium, molybdenum, and chromium; die steel containing iron, carbon, vanadium, molybdenum, and chromium; die steel containing iron, carbon, silicon, manganese, sulfur, chromium, molybdenum, and/or tungsten, vanadium, nickel, copper, and aluminum; and the like.

Forged steel is a material made by heating a steel ingot formed by casting molten steel in a mold or a steel slab made from such a steel ingot; molding after forging with presses and hammers, or after rolling and forging; and carrying out a heat treatment. Known forged steel can be used, including, for example, forged steel mainly composed of iron and containing carbon, chromium, and nickel; forged steel mainly composed of iron and containing silicon, chromium, and nickel; forged steel containing nickel, chromium, and molybdenum; forged steel mainly composed of iron and containing carbon, silicon, manganese, nickel, chromium, molybdenum, and vanadium; forged steel mainly composed of iron and containing carbon, silicon, manganese, nickel, chromium, and molybdenum.

The laser processing mask 1 can be made, for example, by forming a plurality of the apertures 10 with a predetermined shape on a substrate made of, for example, copper and stainless steel, by cutting, electric discharge machining, the photolithography method, or etching. As necessary, at least the surface of the mask 1 may include a material with a high reflectivity to laser, or a cover layer made of such a material may be formed on the surface of the mask 1, in order to decrease damage to the mask 1 by laser. Such a material includes, for example, gold, silver, and aluminum. These materials are particularly effective for laser light with a wavelength of 532 nm.

FIG. 3 is a top view schematically illustrating the shape of apertures 15 of a laser processing mask according to another embodiment. The laser processing mask (not shown) according to another embodiment has the same configuration as that of the laser processing mask 1, except that it includes a plurality of apertures 15 instead of the apertures 10. The aperture 15 is characterized in that the end portion of protrusions 16, 17, 18, and 19 is not acute angled but semicircular or circular arced.

In the aperture 15, apexes 16a, 17a, 18a, and 19a of the indentations of the sides connecting adjacent pairs of protrusions selected from the protrusions 16, 17, 18, and 19 are preferably provided so that these apexes are in contact with circle A shown by the dash-double dotted line. Circle A is an inscribed circle of the aperture 15, centered at an intersection point 15a of a dash-dotted line connecting the apex 16x of the protrusion 16 and the apex 17x of the protrusion 17, and a dash-dotted line connecting the apex 18x of the protrusion 18 and the apex 19x of the protrusion 19. The aperture 15 has such characteristics.

The aperture 15 has the same configuration as that of the aperture 10, except for the two characteristics described above.

In the aperture 15, for example, the four protrusions 16, 17, 18, and 19 are formed radially from the center 15a of the aperture 15 toward the peripheral portion of the aperture 15. Also, in the aperture 15, the protrusions 16 and 17, and the protrusions 18 and 19 are formed so that these pairs of protrusions oppose each other with the center 15a of the aperture 15 therebetween. Furthermore, the shape of an imaginary plane formed by connecting the apexes 16x, 17x, 18x, and 19x of the respective protrusions is substantially a diamond. The configuration other than the above is also the same as that of the aperture 10.

Because the end portions of the protrusions 16, 17, 18, are 19 semicircular, the laser processing mask in which a plurality of the apertures 15 are formed is suitable for forming recesses having, for example, a shape that is substantially approximate to a diamond.

FIG. 4 is a top view schematically illustrating the shape of apertures 20 of a laser processing mask according to another embodiment. The laser processing mask (not shown) according to another embodiment has the same configuration as that of the laser processing mask 1, except that it includes a plurality of the apertures 20 instead of the apertures 10. The aperture 20 has the same configuration as that of the aperture 10, except that the end portions of protrusions 21, 22, 23, and 24 are not acute angled, but semicircular, the four sides of the aperture 20 are formed of curves instead of straight lines, and the indentation of the side between two adjacent protrusions is curved. When using a laser processing mask including the apertures 20 having the shape shown in FIG. 4, the dimension reproducibility is particularly high.

In the aperture 20, for example, the four protrusions 21, 22, 23, and 24 are formed radially from the center 20a of the aperture 20 toward the peripheral portion of the aperture 20. Also, in the aperture 20, the protrusions 21 and 22, and the protrusions 23 and 24 are formed so that these pairs of protrusions oppose each other with the center 20a of the aperture 20 therebetween. Furthermore, the shape of an imaginary plane formed by connecting the apexes 21x, 22x, 23x, and 24x of the respective protrusions is substantially a diamond. The configuration other than the above is also the same as that of the aperture 10.

Because the end portions of the protrusions 21, 22, 23, and 24 are semicircular, the laser processing mask in which the plurality of the apertures 20 are formed is suitable for forming recesses having the shape of, for example, a rectangle, a diamond, an ellipse, or an oval with laser-irradiation dimensions that are substantially the same as the dimensions between respective apexes and with round apexes, especially a diamond or oval with curved corners.

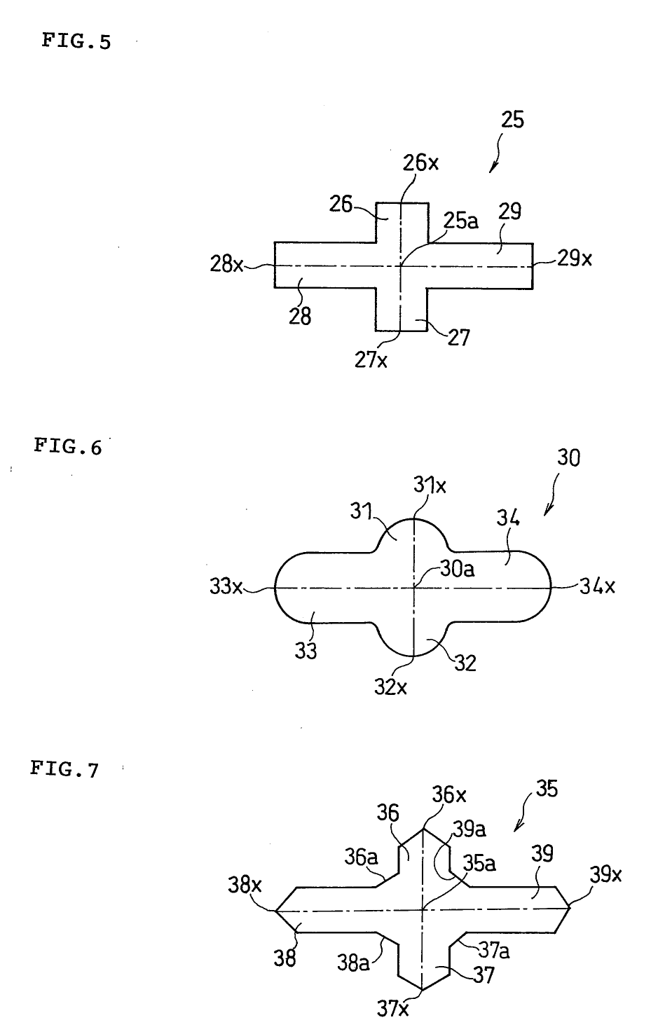

FIG. 5 is a top view schematically illustrating the shape of apertures 25 of a laser processing mask according to another embodiment. The laser processing mask (not shown) according to another embodiment has the same configuration as that of the laser processing mask 1, except that it includes a plurality of the apertures 25 instead of the apertures 10. The aperture 25 has the same configuration as that of the aperture 10, except that the end portions of protrusions 26, 27, 28, and 29 are rectangular, and the protrusions 26, 27, 28, and 29 are formed so that their width is the same along their length from the center 25a of the aperture 25 to their peripheral portions.

In the aperture 25, for example, the four protrusions 26, 27, 28, and 29 are formed radially from the center 25a of the aperture 25 toward the peripheral portion of the aperture 25. Also, in the aperture 25, the protrusions 26 and 27, and the protrusions 28 and 29 are formed so that these pairs of protrusions oppose each other with the center 25a of the aperture 25 therebetween. Furthermore, the shape of an imaginary plane formed by connecting the apexes 26x, 27x, 28x, and 29x of the respective protrusions is substantially a diamond. The configuration other than the above is also the same as that of the aperture 10.

The protrusions 26, 27, 28, and 29 are not tapered, the shape of their end portions is rectangular, and the width of the protrusions 26, 27, 28, and 29 is substantially the same along their length. Accordingly, the laser processing mask in which the plurality of the apertures 25 are formed is suitable for forming recesses having the shape of, for example, a rectangle, a diamond, a hexagon, and an octagon with laser-irradiation dimensions that are substantially the same as the dimensions between respective apexes and with round apexes.

FIG. 6 is a top view schematically illustrating the shape of apertures 30 of a laser processing mask according to another embodiment. The laser processing mask (not shown) according to another embodiment has the same configuration as that of the laser processing mask 1, except that it includes a plurality of the apertures 30 instead of the apertures 10. The aperture 30 has the same configuration as that of the aperture 25, except that the end portions of protrusions 31, 32, 33, and 34 are semicircular.

In the aperture 30, for example, the four protrusions 31, 32, 33, and 34 are formed radially from the center 30a of the aperture 30 toward the peripheral portion of the aperture 30. Also, in the aperture 30, the protrusions 31 and 32, and the protrusions 33 and 34 are formed so that these pairs of protrusions oppose each other with the center 30a of the aperture 30 therebetween. Furthermore, the shape of an imaginary plane formed by connecting the apexes 31x, 32x, 33x, and 34x of the respective protrusions is substantially a diamond. The configuration other than the above is also the same as that of the aperture 25, that is, the aperture 10.

The protrusions 31, 32, 33, and 34 are not tapered, the shape of the end portions is semicircular, and the width of the protrusions 33 and 34 is substantially the same along their length. Accordingly, the laser processing mask in which the plurality of the apertures 30 are formed is suitable for forming recesses having the shape of, for example, a rectangle or a diamond, with laser-irradiation dimensions that are substantially the same as the dimensions between respective apexes and with round apexes.

FIG. 7 is a top view schematically illustrating the shape of apertures 35 of a laser processing mask according to another embodiment. The laser processing mask (not shown) according to another embodiment has the same configuration as that of the laser processing mask 1, except that it includes a plurality of the apertures 35 instead of the apertures 10. The aperture 30 has the same configuration as that of the aperture 25, except that the end portions of protrusions 36, 37, 38, and 39 are triangular.

In the aperture 35, for example, the four protrusions 36, 37, 38, and 39 are formed radially from the center 35a of the aperture 35 toward the peripheral portion of the aperture 35. Also, in the aperture 35, the protrusions 36 and 37, and the protrusions 38 and 39 are formed so that these pairs of protrusions oppose each other with the center 35a of the aperture 35 therebetween. Furthermore, the shape of an imaginary plane formed by connecting the apexes 36x, 37x, 38x, and 39x of the respective protrusions is substantially a diamond. The configuration other than the above is also the same as that of the aperture 25, that is, the aperture 10.

In the aperture 35, linear indent portions 36a, 37a, 38a, and 39a are formed between two protrusions. The indent portions 36a, 37a, 38a, and 39a are preferably formed so that a shape formed by connecting four intersection points of their extension lines is a square. In this way, the dimension precision and shape reproducibility are further improved.

The protrusions 36, 37, 38, and 39 are not tapered, their end portions are a triangle shape, and the width of the protrusions 36, 37, 38, and 39 is substantially the same along their length. Accordingly, the laser processing mask in which the plurality of the apertures 35 are formed is suitable for forming recesses having the shape of, for example, a rectangle or a diamond, with laser-irradiation dimensions that are substantially the same as the dimensions between respective apexes.

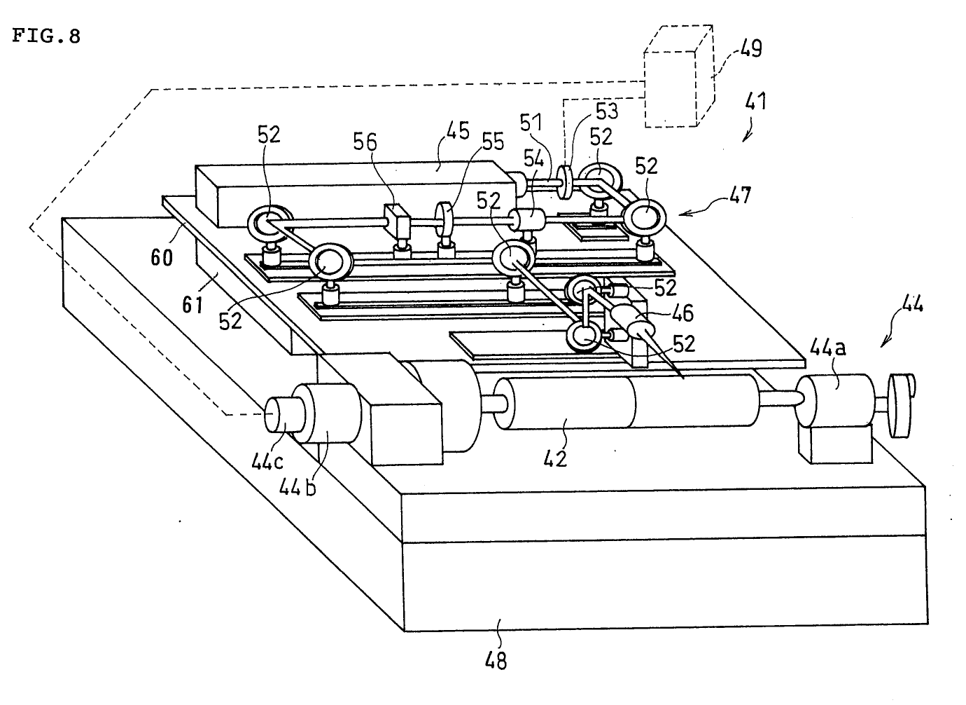

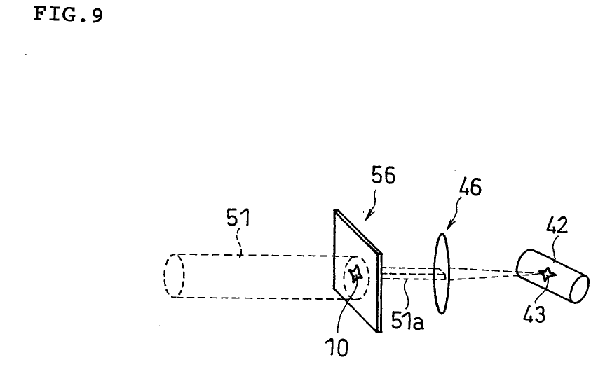

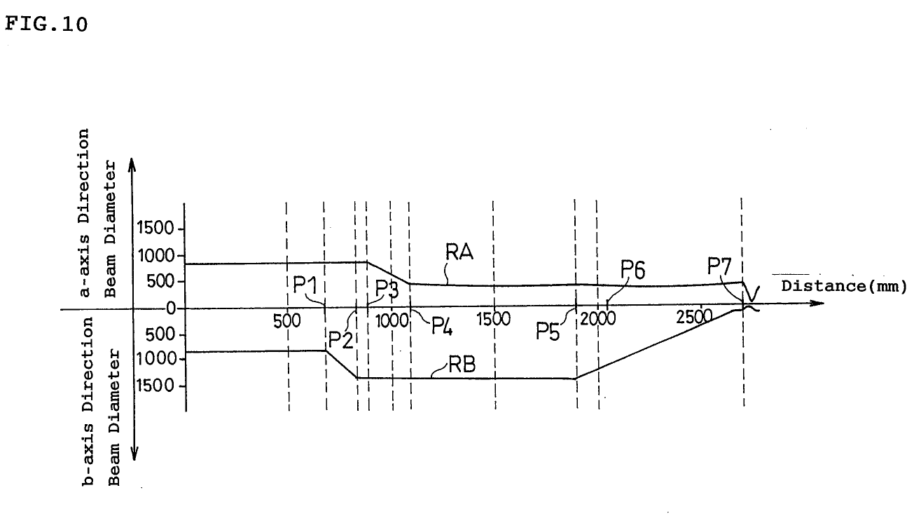

A laser processing method of the present invention can be carried out in the same manner as the conventional laser processing method, except that a laser processing mask of the present invention is used as the mask. The laser processing method of the present invention is carried out, for example, by using a laser processing device 41 shown in FIG. 8. FIG. 8 is a perspective view schematically illustrating the configuration of the laser processing device 41. FIG. 9 is a perspective view illustrating the operation of the mask 1 in the laser processing device 41 shown in FIG. 8. FIG. 10 is a graph illustrating an example of the operation of a beam diameter adjusting means 55.

The laser processing device 41 includes a roller rotator 44, a laser oscillator 45, a working head 46, a light guide path 47, a stone surface plate 48, and a controlling means 49, and forms a plurality of recesses 43 on the surface (circumferential surface) of a roller 42 rotatably supported by the roller rotator 44.

As the roller 42, for example, a metal roller, or a surface cover roller is used.

The roller rotator 44 is a member that supports the roller 42 so that the roller 42 is rotatable in its circumferential direction and drives the roller 42 to rotate in its circumferential direction. The roller rotator 44 includes a tailstock 44a, motor 44b, and an encoder 44c. The tailstock 44a supports the roller 42 so that the roller 42 is rotatable in the circumferential direction. The motor 44b drives the roller 42 to rotate. The encoder 44c detects, for example, the number of revolutions of the roller 42, the rotation angle per rotation, and the angular velocity, converts the results of the detection into electric signals, and outputs the results to the controlling means 49.

The controlling means 49 stores the detection results inputted from the encoder 44c and performs computation based on the detection results, to determine whether or not a further rotation is necessary, and if a further rotation is necessary, to determine the number of revolutions and/or the rotation angle. Furthermore, the controlling means 49 converts the calculation results into electric signals, and outputs the signals to, for example, a motor 44b, to control the rotation of the roller 42 performed by the motor 44b.

The laser oscillator 45 is a member that outputs laser light 51. Known laser oscillators may be used as the laser oscillator 45, including, for example, a solid laser oscillator (Nd:YAG laser, Nd:YVO₄ laser) using a laser medium made by adding neodymium ions to a YAG crystal (yttrium, aluminum, garnet) or a YVO₄ crystal.

The wavelength of the laser light 51 outputted from the laser oscillator 45 is preferably 100 nm or more and below 600 nm, and further preferably 266 nm or more and below 600 nm. When the wavelength is below 100 nm, the power of the laser light 51 is insufficient, and therefore it may take a long time to form the recesses 43. Also, the recess 43 having a desired shape and dimensions may not be formed. On the other hand, when the wavelength is 600 nm or more, the diffraction may become high, possibly resulting in a reduced accuracy.

For outputting the laser light 51 having a wavelength within the above described range, for example, a Nd:YAG laser in which higher harmonics are generated by using a nonlinear optical crystal is preferably used as the laser oscillator 45. With this Nd:YAG laser, green laser light with a wavelength 532 nm, and laser light with a wavelength of 355 nm can be outputted.

The working head 46 is a member that converges the laser light 51, and applies the light to the circumferential surface of the roller 42. The working head 46 includes a converging lens, not shown, that converges the laser light 51 sent via the light guide path 47, and applies the light to the circumferential surface of the roller 42.

The focal length of the working head 46 is preferably 20 to 200 mm, further preferably about 40 mm. When the focal length is below 20 mm, dust caused by the roller 42 may attach to the converging lens of the working head 46, which may prevent image formation. On the other hand, when the focal length exceeds 200 mm, because of a decrease in NA (numerical aperture), image formation may also not be achieved. The imaging magnification of the working head 46 is preferably 5 to 40 times, and further preferably about 16 times.

The light guide path 47 is a member that guides the laser light 51 outputted from the laser oscillator 45 to the working head 46, and includes a reflection mirror 52, a shutter device 53, an attenuator 54, a beam diameter adjusting means 55, and a mask part 56.

The reflection mirror 52 is disposed in a plurality of numbers, and is a member that guides the laser light 51 to the working head 46.

The shutter device 53 includes a light shielding member (not shown), and a driving means (not shown), and is a member that allows pass of the laser light 51 towards the downstream side of the light guide path 47, or shields the light. The light shielding member is supported by a supporting member (not shown) so that it can be reciprocated. The driving reciprocates the light shielding member between the position where the laser light 51 is not prevented from being passed, and the position where the laser light 51 is prevented from being passed. As the driving means, for example, an air cylinder is used. The operation of the shutter device 53 is controlled by the controlling means 49 according to the output signal of the encoder 44c.

The attenuator 54 controls the output of the laser light by adjusting the direction of polarization of the laser light 51, and allowing only a component of a specific direction of polarization to pass or reflect.

The beam diameter adjusting means 55 is formed, for example, by at least one lens, and adjusts the beam diameter of the laser light 51, whose output is being adjusted by the attenuator 54. To be more specific, the beam diameter adjusting means 55 improves energy efficiency, protects the mask part 56, and decreases aberrations caused at the converging lens above the working head, by adjusting the energy distribution and the spread angle of the beam of the laser light 51 so that the energy is high at regions corresponding to the laser light passing apertures 10 of the mask part 56.

An example of the operation of the beam diameter adjusting means 55 is shown in FIG. 10. In FIG. 10, the enlargement of the beam diameter of the laser light 51 in the vertical direction is commenced with a cylindrical lens (not shown) provided at point P1 (where the distance from the laser oscillator 45 is about 735 mm) of the light guide path 47. Then, with a cylindrical lens (not shown) provided at point P2 (where the distance from the laser oscillator 45 is about 885 mm), the enlargement of the vertical beam diameter is stopped.

Further, with a cylindrical lens provided at point P3 (where the distance from the laser oscillator 45 is about 985 mm), the reduction of the beam diameter in the horizontal direction is commenced, and with a cylindrical lens provided at point P4 (where the distance from the laser oscillator 45 is about 1185 mm) the reduction of the beam diameter in the vertical direction is stopped.

Further, with a circular lens provided at point P5 (where the distance from the laser oscillator 45 is about 1985 mm) the laser light is converged in the proximity of the lens of the working head, and with the mask part 56 provided at point P6 (where the distance from the laser oscillator 45 is about 2105 mm), the contour of the laser light is shaped. Afterwards, the laser light 51 is converged by the converging lens of the working head 46 that is disposed at point P7, and applied to the circumferential surface of the roller 42, thereby forming a reduced image of the mask part 56.

The beam diameter adjusting means 55 is not limited to lenses, and may be formed by, for example, a diffraction element (DOE), a slit, or a filter.

The mask part 56 is a member that shapes the contour of the laser light into a desired shape. In this embodiment, the above-described laser processing mask 1 is used as the mask part 56. Therefore the mask part 56 includes, a plurality of apertures 10 formed therein. The apertures 10 serve as the laser light passing apertures. Of the laser light 51, laser light 51a having passed through the apertures 10 is shaped so that its contour has the shape of the aperture 10, and an image of the aperture 10 is formed on the circumferential surface of the roller 42 with the converging lens of the working head 46.

Preferably, the shape of the aperture 10 of the mask part 56 is adjusted appropriately according to, for example, the NA of the converging lens of the working head 46, and the wavelength of the laser light 51. For example, when the wavelength of the laser light 51 is about 200 nm, the aperture 10 preferably has a shape that does not include an end having a radius of curvature of below 10 μm. When the NA of the converging lens of the working head 46 is 0.3, and the wavelength of the laser light 51 is 500 nm, the diffraction limit will be 2.0 μm. When the first-order diffracted light is also used, the minimum beam diameter is about 3 μm, and a magnification of 16 times, the radius of curvature needs to be set to 24 μm or more. That is, in this case, the aperture 10 is preferably shaped so that it does not include an end having a radius of curvature of below 24 μm.

The laser oscillator 45, the working head 46, and the light guide path 47 are integrally supported by a supporting board 60. This supporting board 60 is supported by an actuator 61, so that it can be reciprocated in the longitudinal direction of the roller 42 and in the direction perpendicular to the longitudinal direction of the roller 42 to be mounted on the roller rotator 44.

The stone surface plate 48 supports the roller rotator 44, the supporting board 60 that supports the laser oscillator 45, the working head 46, and the light guide path 47, and the actuator 61.

The controlling means 49 opens or closes the shutter device 53, so that the laser light 51 is applied every time the roller 42 is rotated at a predetermined angle for a predetermined time, according to, for example, the detection results of the encoder 44c. In this way, on the circumferential surface of the roller 42 rotated by the roller rotator 44, the recesses 43 are formed row by row with a predetermined angle pitch from one end (for example, from the end face of the tailstock 44a). After the roller 42 completes one rotation the laser light 51 is repeatedly applied to the same areas, preferably a plurality of times (for example, five times), and thereby the recesses 43 are formed.

The time for the irradiation of the laser light 51 is not particularly limited, but preferably 10 ps to 200 ns per application. With the irradiation time of below 10 ps, the thermal conduction by the irradiation of the laser light 51 is not caused, so that only one layer of atoms can be removed, which may lead to an insufficient formation of the recess 43. On the other hand, when it exceeds 200 ns, the laser light 51 may sweep the surface of the roller 42 by the rotation of the roller 42.

The laser processing device 41 may include a blowing device (not shown). The blowing device is provided in the proximity of the roller 42 supported by the roller rotator 44, and blows gas or liquid to the surface of the roller 42, preferably to the portion to be formed the recess 43 on the surface of the roller 42. The timing of the blowing by the blowing device may be, but not particularly limited to, before irradiation of the laser light 51; the period after irradiation of the laser light 51 to the circumferential surface of the roller 42 and before the next irradiation of the laser light 51 to the same portion; and after irradiation of the laser light 51. With this blowing, dust can be removed from the area of the circumferential surface of the roller 42 where the recesses 43 are formed. Also, because the effect of cooling the roller 42 can be increased, the expansion of the surface of the roller 42 due to the heat resulting from irradiation of the laser light 51 is decreased, leading to a further improvement of the dimensional precision and the shape precision of the formed recess 43.

With the laser processing device 41, by using a laser processing mask of the present invention, the recess 43 with minute dimensions of about several micrometers to several tens of micrometers can be formed on the surface of the roller 42, i.e., a workpiece, with very high dimensional precision and shape precision.

By using a laser processing mask of the present invention, for example, a pattern of projections and recesses with high dimensional precision and shape precision having minute dimensions of about several micrometers to several tens of micrometers can be easily formed on the surface of the workpiece. When the workpiece is in a roller form, for example, the workpiece can be used suitably for forming projections of a minute size on the surface of a metal plate. By using this metal plate including minute projections formed therein, for example, as a current collector of a battery, it is possible to provide a battery with a high capacity, excellent long-time durability, and excellent safety.

In the following, the present invention is described in detail by using examples, and comparative examples.

### EXAMPLES

### Example 1

A stainless steel plate (SUS304) with a thickness of 0.3 mm, and dimensions of 22 mm×22 mm was subjected to electric discharge machining, thereby obtaining a laser processing mask of the present invention, including apertures 15 having a shape as shown in FIG. 3 and being arranged in a staggered configuration as shown in FIG. 1.

Specifically, the electric discharge machining was performed as follows using a V ram-type electric discharge machining apparatus including a head with a tungsten electrode having a tip end diameter of 8 μm attached thereto, the head being supported such that precise movement was possible by a servo motor. First, a stainless steel plate (SUS304) with a thickness of 0.3 mm and dimensions of 22 mm×22 mm was placed on the workpiece table of the electric discharge machining apparatus. Next, a power supply through an RC cirtuit was connected across the stainless steel plate and the tungsten electrode. While applying a voltage of 70 V to the tungsten electrode by setting the resistance and capacitance of the RC circuit at 1 kO and 10 pF, respectively, the electrode head was moved in accordance with the contour of the aperture 15 shown in FIG. 3. The aperture 15 was thus formed.

The size of the aperture 15 was set as in the following: L₁: 0.32 mm, L₂: 0.16 mm, the radius of curvature of the end portion of the respective protrusions 16 to 19: 10 μm, and the diameter of inscribed circle A: 50 μm. Additionally, the pitches were set as in the following: pitch P₁: 0.32 mm, and pitch P₂: 64 μm. This mask had apertures with a shape of a diamond, and was made for the purpose of forming a diamond-shaped recess with a longer diagonal line of 20 μm and a shorter diagonal line of 10 μm.

A unit that allows second harmonics to generate from Nb: YAG laser light and outputs green light with a wavelength of 532 nm was mounted, as a laser oscillator 45, on the laser processing device 41. The intensity of the laser light outputted from the working head 46 per irradiation was set to 23 μJ. Also, the converging lens and the focal length were adjusted so that the imaging magnification of the working head was 16 times. That is, the image-forming size of the working head was 1/16 times the aperture 15 of the laser processing mask, and the dimension corresponding to L₁ was 20 μm, and the dimension corresponding to L₂ was 10 μm. Furthermore, the laser processing mask was set as the mask part 56 so a total of four apertures 15, i.e., two pairs of adjacent apertures located in the longitudinal side and the latitudinal side serve as the laser light-passing apertures.

Between the roller rotator 44 and the tailstock 44a of the laser processing device 41 described above, a forged steel roller (manufactured by Daido Machinery, Ltd., diameter 50 mm, roll width 100 mm) was mounted, and laser light was applied five times to the surface of the forged steel roller, for an irradiation time of 50 nanoseconds, and an irradiation interval of 1 millisecond. After the irradiation of the laser light, the laser light irradiation area was moved by 40 μm in the longitudinal direction of the forged steel roll or by 56 μm in the circumferential direction, and laser light was applied in the same manner five times.

The circumferential movement was carried out by rotating the forged steel roller. The longitudinal movement, and the circumferential movement were carried out five times each, and the laser light irradiation of five times was carried out for a total of 25 areas, thereby forming 100 recesses in a staggered configuration. Furthermore, the pitch of the recesses in the longitudinal direction (longitudinal direction of the forged steel roll) was about 20 μm, and the pitch in the latitudinal direction (circumferential direction of the forged steel roll) was about 14 μm. Because the recesses were formed in a staggered configuration, the pitch is the distance between a center line of a horizontal (longitudinal direction) or vertical (latitudinal direction) row of the recesses and a center line of the adjacent row phase from the aforementioned row. The center line of a row of the recesses is a line connecting the center points of the recesses corresponding to the center points of the apertures in the laser processing mask.

The aperture shape of the 100 recesses obtained in the above described manner was observed by using a laser microscope (product name: VK-9500, manufactured by Keyence corporation); the diameter and the depth was measured; and an average value was obtained. As a result, it was found that the aperture shape of the recesses was substantially a diamond, with a longer diagonal line of 19.5 μm and a shorter diagonal line of 9.8 μm. These values substantially agreed with the designed values. Also, the lengths of the longer diagonal line and the shorter diagonal line substantially agreed with the values obtained by dividing L₁ and L₂ of the aperture 15 in the mask by the imaging magnification. Furthermore, the area of the aperture portion of the recess was 120% of the designed value. As described above, by carrying out laser processing by using the mask of the present invention, recesses could be formed with high shape reproducibility and dimensional precision.

### Example 2

A laser processing mask of the present invention was made in the same manner as in Example 1, except that the aperture 15 was changed to the aperture 10 shown in FIG. 1 or FIG. 2. In the aperture 10, L₁ and L₂ were set to, L₁: 0.32 mm and L₂: 0.16 mm, and the dimensions of a rectangle formed by connecting the apexes of the indentations of the sides between the protrusions were set to: 0.16 mm×0.08 mm. This mask was made for the purpose of forming recesses having its aperture shape of a diamond with a longer diagonal line of 20 μm and a shorter diagonal line of 10 μm.

100 recesses were formed in a staggered configuration on the surface of a forged steel roller in the same manner as in Example 1, except that this mask was used. The pitch of the recess in the longitudinal direction (the longitudinal direction of the forged steel roll) was about 20 μm, and the pitch in the latitudinal direction (the circumferential direction of the forged steel roll) was about 14 μm.

As a result of carrying out laser microscope observation on the obtained recesses in the same manner as in Example 1, it was found that the aperture shape of the recesses was substantially a diamond, with a longer diagonal line of 18.5 μm and a shorter diagonal line of 10.2 μm. These dimensions substantially agreed the designed values. Furthermore, the lengths of the longer diagonal line and the shorter diagonal line substantially agreed with the values of L₁ and L₂ of the aperture 10 in the mask divided by the imaging magnification. Furthermore, the area of the aperture portion of the recesses was 129% of the designed value. In this way, by carrying out laser processing by using a mask of the present invention, recesses could be formed with high shape reproducibility and dimensional precision were formed.

### Example 3

A laser processing mask of the present invention was made in the same manner as in Example 1, except that the aperture 15 was changed to the aperture 20 shown in FIG. 4. In the aperture 20, L₁ and L₂ were set to, L₁: 0.32 mm, L₂: 0.16 mm, the radius of curvature of protrusions 21 and 22 were set to 20 μm, the radius of curvature of protrusions 23 and 24 was set to 30 μm, and the radius of curvature of the indentation between two protrusions was set to 30 μm. This mask was made for the purpose of forming recesses having its aperture shape of a diamond with a longer diagonal line of 20 μm and a shorter diagonal line of 10 μm.

100 recesses were formed in a staggered configuration on the surface of a forged steel roller in the same manner as in Example 1, except that this mask was used. The pitch of the recess in the longitudinal direction (the longitudinal direction of the forged steel roll) was about 20 μm, and the pitch in the latitudinal direction (the circumferential direction of the forged steel roll) was about 14 μm.

As a result of carrying out scanning electron microscope observation on the obtained recesses in the same manner as in Example 1, it was found that the aperture shape of the recesses was substantially a diamond, with a longer diagonal line of 20.1 μm and a shorter diagonal line of 10.3 μm. These dimensions substantially agreed with the designed values. Furthermore, the lengths of the longer diagonal line and the shorter diagonal line substantially agreed with the values of L₁ and L₂ of the aperture 20 in the mask divided by the imaging magnification. Furthermore, the area of the aperture portion of the recesses was 133% of the designed value. In this way, by carrying out laser processing by using a mask of the present invention, recesses could be formed with high shape reproducibility and dimensional precision were formed.

### Example 4

A laser processing mask of the present invention was made in the same manner as in Example 1, except that the aperture 15 was changed to aperture 25 shown in FIG. 5. In the aperture 25, L₁ and L₂ were set to, L₁: 0.32 mm, L₂: 0.16 mm, and the widths of protrusions 26, 27, 28, and 29 were set to: 50 μm. This mask was made for the purpose of forming recesses having its aperture shape of a diamond with a longer diagonal line of 20 μm, and a shorter diagonal line of 10 μm.

100 recesses were formed in a staggered configuration on the surface of a forged steel roller in the same manner as in Example 1, except that this mask was used. The pitch of the recess in the longitudinal direction (the longitudinal direction of the forged steel roll) was about 20 μm, and the pitch in the latitudinal direction (the circumferential direction of the forged steel roll) was about 14 μm.

As a result of carrying out scanning electron microscope observation on the obtained recesses in the same manner as in Example 1, it was found that the aperture shape of the recesses was substantially a diamond, with a longer diagonal line of 21.1 μm and a shorter diagonal line of 10.9 μm. These dimensions substantially agreed with the designed values. Furthermore, the lengths of the longer diagonal line and the shorter diagonal line substantially agreed with the values of L₁ and L₂ of the aperture 25 in the mask divided by the imaging magnification. Furthermore, the area of the aperture portion of the recesses was 140% of the designed value. In this way, by carrying out laser processing by using a mask of the present invention, recesses could be formed with high shape reproducibility and dimensional precision were formed.

### Example 5

A laser processing mask of the present invention was made in the same manner as in Example 1, except that the aperture 15 was changed to aperture 30 shown in FIG. 6. In the aperture 30, L₁ and L₂ were set to, L₁: 0.32 mm, L₂: 0.16 mm, the radius of curvature of the end portions of protrusions 31, 32, 33, and 34 was set to: 24 μm, and the width of the protrusions 31, 32, 33, and 34 was set to: 48 μm. This mask was made for the purpose of forming recesses having its aperture shape of a diamond with a longer diagonal line of 20 μm, and a shorter diagonal line of 10 μm.

100 recesses were formed in a staggered configuration in the same manner as in Example 1 on the surface of the forged steel roller, except that this mask was used. The pitch of the recess in the longitudinal direction (the longitudinal direction of the forged steel roll) was about 20 μm, and the pitch in the latitudinal direction (the circumferential direction of the forged steel roll) was about 14 μm.

As a result of carrying out scanning electron microscope observation on the obtained recesses in the same manner as in Example 1, it was found that the aperture shape of the recesses was substantially a diamond, with a longer diagonal line of 20.5 μm, and a shorter diagonal line of 10.1 μm. These dimensions substantially agreed with the designed values. Furthermore, the lengths of the longer diagonal line and the shorter diagonal line substantially agreed with the values of L₁ and L₂ of the aperture 30 in the mask divided by the imaging magnification. Furthermore, the area of the aperture portion of the recesses was 135% of the designed value. In this way, by carrying out laser processing by using a mask of the present invention, recesses could be formed with high shape reproducibility and dimensional precision were formed.

### Example 6

A laser processing mask of the present invention was made in the same manner as in Example 1, except that the aperture 15 was changed to aperture 35 shown in FIG. 7. In the aperture 35, L₁ and L₂ were set to, L₁: 0.32 mm, L₂: 0.16 mm, the angle of the end portion of the protrusions 36, 37, 38, and 39 was set to: 90°, the width of the protrusions 36, 37, 38, and 39 was set to: 50 μm, and a shape formed by connecting four intersection points made by extending indentations 36a, 37a, 38a, and 39a of straight lines was set to a square with the side of 90 μm. This mask was made for the purpose of forming recesses having its aperture shape of a diamond with a longer diagonal line of 20 μm, and a shorter diagonal line of 10 μm.

100 recesses were formed in a staggered configuration on the surface of a forged steel roller in the same manner as in Example 1, except that this mask was used. The pitch of the recess in the longitudinal direction (the longitudinal direction of the forged steel roll) was about 20 μm, and the pitch in the latitudinal direction (the circumferential direction of the forged steel roll) was about 14 μm.

As a result of carrying out scanning electron microscope observation on the obtained recesses in the same manner as in Example 1, it was found that the aperture shape of the recesses was substantially a diamond, with a longer diagonal line of 20.4 μm and a shorter diagonal line of 10.2 μm. These dimensions substantially agreed with the designed values. Furthermore, the lengths of the longer diagonal line and the shorter diagonal line substantially agreed with the values of L₁ and L₂ of the aperture 35 in the mask divided by the imaging magnification. Furthermore, the area of the aperture portion of the recesses was 138% of the designed value. In this way, by carrying out laser processing by using a mask of the present invention, recesses could be formed with high shape reproducibility and dimensional precision were formed.

### Comparative Example 1

A mask was made in the same manner as in Example 1, except that the aperture made was a diamond with L₁: 0.32 mm and L₂: 0.16 mm. Recesses were made on the surface of a forged steel roller in the same manner as in Example 1, except that this mask was used. As a result of carrying out scanning electron microscope observation on the obtained recess, it was found that its shape was ellipse, and the length corresponding to L₁ was about 22.5 μm, and the length corresponding to L₂ was about 11 μm. Furthermore, the area of the aperture portion of the recess was 205% of the designed value of the area of the aperture portion.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A laser processing mask comprising a plurality of apertures perforating said laser processing mask in the thickness direction thereof,
wherein said apertures have a shape in which a plurality of protrusions extend radially from the center of each of said apertures to the peripheral portion thereof.

2. The laser processing mask in accordance with claim 1, wherein said apertures have a shape in which an even number of protrusions are arranged so as to oppose one another with the center of each of said apertures interposed therebetween.

3. The laser processing mask in accordance with claim 1, wherein said apertures have a cross shape in which four protrusions are disposed so that any one of the four protrusions arranged so as to oppose one another with the center of each of said apertures interposed therebetween; and length L₁ of a straight line connecting apexes of one pair of said protrusions opposing each other, and length L₂ of a straight line connecting apexes of the other pair of said protrusions opposing each other are different.

4. The laser processing mask in accordance with claim 1, wherein L₁ is 60 μm to 1.2 mm, L₂ is 30 to 600 μm, and L₁ is larger than L₂.

5. The laser processing mask in accordance with claim 1, wherein sides of said apertures are indented toward the center of said apertures with respect to an imaginary line formed by connecting the apexes of adjacent of said protrusions.

6. The laser processing mask in accordance with claim 1, wherein an imaginary plane formed by connecting apexes of adjacent of said protrusions is substantially in the shape of a polygon.

7. The laser processing mask in accordance with claim 6, wherein said polygon is a tetragon, a hexagon, or an octagon.

8. The laser processing mask in accordance with claim 1, wherein the end portion of said protrusions is semicircular.

9. The laser processing mask in accordance with claim 1, used in laser processing of hard metal, high-speed steel, or forged steel.

10. The laser processing mask in accordance with claim 9, used in laser processing of a roller comprising a laser processing layer including hard metal, high-speed steel, or forged steel on at least its circumferential surface.

11. A laser processing method, comprising the step of:
applying laser light to a surface of a workpiece through the laser processing mask in accordance with claim 1.
